(19) United States
(12) Patent Application Publication
(10) Pub. No.: US 2015/0317384 A1
(43) Pub. Date: Nov. 5, 2015

(54) Methods and Systems for Graph Database Processing of Complex Entity Relationships

(71) Applicant: Entity Keeper, LLC, Charlotte, NC (US)

(72) Inventors: Phil Rooney, Dublin, NH (US); Bob Wilkins, Peterborough, NH (US); Cy Tidd, Derry, NH (US); Shaun Sutherland, Manchester, NH (US)

(21) Appl. No.: 14/621,786

(22) Filed: Feb. 13, 2015

Related U.S. Application Data
(60) Provisional application No. 61/939,401, filed on Feb. 13, 2014.

(51) Int. Cl. G06F 17/30; G06F 3/0482; G06F 3/0484

(52) U.S. Cl. CPC G06F 17/30604; G06F 17/30958; G06F 17/30312; G06F 3/04842; G06F 3/0482

(57) ABSTRACT

The present invention relates to systems and methods of graph database processing and displaying complex relationships in a computer implemented program, for ease of review by a user.

### FIELD OF THE INVENTION

The invention pertains in general to computer-implemented methods of graph database processing for visualizing complex relationships. In particular the invention pertains to methods of graph database processing incoming and outgoing relationships of interconnected entities, for ease of review by a user.

### BACKGROUND OF THE INVENTION

A graph database is a database that uses graph structures such as nodes, edges and properties to represent stored data. Nodes in a graph database represent entities such as people, businesses, accounts, or any item that a user may wish to track. Edges are lines that connect the nodes and represent the relationship between each node in a graph database.

Graph database processing of interconnected entities is complex to represent in an easy to review format for a user. As an example, entities with percentage ownership of multiple other entities often results in layers of divided and parallel ownership patterns, which are difficult to process and represent in computer-implemented programs. In many fields, graph database processing and modeling of real-world relationships is challenging to accurately portray, particularly when incoming and outgoing relationships are multi-layered, overlapping, or otherwise complex. The challenge of graph database processing of complex relationships is significant, as entities grow in complexity, with subdivided ownership, contracted obligations, licensed rights and the like, which the inventors seek to simplify in accordance with the embodiments of the present invention. The inventors have developed computer-implemented methods and systems of graph database processing of complex entity relationships, for ease of review by a user. In particular the inventors have developed systems and methods of visualizing incoming and outgoing entity relationship, and showing interconnected relationships between entities.

### SUMMARY OF THE INVENTION

Embodiments of the present invention provide systems and methods of graph database processing and displaying complex relationships between entities in a computer-implemented program, for ease of review by a user. In this regard, one embodiment of the invention, among others, can be broadly summarized by the following features: a computer-implemented method of graph data processing of complex entity relationships, including but not limited to the steps of 1) storing graph data on a processor representing complex entity relationships, 2) generating, with the processor, a listing of incoming relationship information of a first entity by one or more entities, 3) generating, with the processor, a listing of outgoing relationship information by the first entity of the one or more entities, 4) converting said incoming relationship information and said outgoing relationship information using a processor into a single entity box display; and, 5) connecting said incoming relationship information and said outgoing relationship information from said single entity box display with single edges directed to incoming relationship information and single edges directed to outgoing relationship information in said one or more related entity boxes, wherein said single edges each connect to one incoming relationship and one outgoing relationship in said one or more related entity box.

The present embodiment may further include the step of preventing single edges from intersecting a single entity box and any related entity boxes, such that the computer implemented methods of grabbing and displaying entity relationship information can be displayed in an easy to review method for a user. In addition, the present embodiment may include the step of providing incoming relationships on the left side of an entity box and the step of providing outgoing relationships on the right side of an entity box.

The present embodiment may further include the step of providing a computer implemented highlighted display of detailed single entity relationship information when an entity box is selected or hovered over by a user, for ease of review by the user. In yet another embodiment, the method may further include the step of providing a computer implemented 3D image of detailed entity relationship information when an entity box is selected or hovered over, by a user.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims. It should be noted that the language used in the specification has been principally selected for readability and instructional purposes, and may not have been selected to delineate or circumscribe the inventive subject matter.

### DEFINITIONS

Entity: Something that exists by itself, although it need not be of material existence, an individual, a person, an inanimate object, a business or a corporate structure are examples of entities, which can, in essence, be anything.

Bezier Curve: A parametric curve frequently used in computer graphics and related fields.

Ray Intersection: A type of intersection done by extending a line (in this case, a horizontal one) out to the right edge of a graph and determining which box it intersects first. This box is used as a temporary target box to navigate around, upon which the link process returns to the “attempt simple bezier” step and continues through the loop.

Deep Link: A multi-level link from an entity box on the left, to an entity box somewhere on the right-hand side of a chart. The line must go around one or more intersecting entity boxes before attempting the “simple bezier” step and continue through the loop.

S-Link: A line that links two entity boxes on the same level. The line must go around one entity box and then connect to the opposite side of the target box.

Multi-Level Reverse S-Link: A combination of Deep Link and S-Link, only going in reverse. This is typically used to connect a child's child entity as an owner of a parent entity.

### BRIEF DESCRIPTION OF THE FIGURES

Many aspects of the invention can be better understood with reference to the following drawings. The components in the drawings are not necessarily to scale, emphasis instead being placed upon clearly illustrating the principles of the present invention.

FIG. 1 shows a diagram of a method of displaying complex entity relationships in accordance with one embodiment of the present invention.

FIGS. 2A and 2B shows a flowchart of a computer-implemented method for processing complex entity relationships using the systems and methods in accordance with one embodiment of the present invention.

FIG. 3 shows a flowchart of the data processing steps used by a computer-implement program in accordance with one embodiment of the present invention.

### DETAILED DESCRIPTION OF THE INVENTION

The invention provides systems and methods for graph database processing of complex entity relationships in a computer-implemented program. In particular the invention pertains to computer-implemented methods of graph database processing of incoming and outgoing relationships of interconnected entities, for ease of review by a user.

In accordance with one embodiment of the present invention, a method for processing and displaying graph data related to complex entity relationships, in a computer-implemented program, is described. The method in accordance with this embodiment includes but is not limited to the steps of: 1) storing graph data on a processor representing complex entity relationships, 2) generating, with said processor, a listing of incoming relationship information of a first entity by one or more entities, 3) generating, with the processor, a listing of outgoing relationship information by the first entity of said one or more entities, 4) converting the incoming relationship information and the outgoing relationship information using a processor into a single entity box display; and, 5) connecting the incoming relationship information and the outgoing relationship information from the single entity box display with single edges directed to incoming relationship information and single edges directed to outgoing relationship information in the one or more related entity boxes, wherein the single edges each connect to one incoming relationship and one outgoing relationship in the one or more related entity box. In accordance with this embodiment, in yet another step of preventing edges from intersecting an entity box, the present embodiment depicts relationships with edges that are specific to the incoming and outgoing relationships of each entity and easy to decipher by a user.

In yet another step of providing incoming relationship information on the left side of an entity box and the step of providing outgoing relationship information on the right side of an entity box, the present embodiment requires consistent relationship linking styles for each node or entity for an optimized graph display using a computer-implemented processor to decipher data and display entity relationship information in accordance with the present embodiment, and for ease of review by a user.

The present embodiment may also further include the steps of providing detailed entity relationship information when an entity box is selected or hovered over, by a user and the step of highlighting the detailed entity relationship information when the entity box is selected or hovered over. In this embodiment, the step of highlighting may include highlighting the edges and the nodes when the entity box is selected, for convenience and ease of review. In addition, in yet another step in accordance with the present embodiment of providing a 3D image of detailed entity relationship information when an entity box is selected or hovered over by a user may further provide ease of review of information to a user.

In another embodiment of the present invention, the step of providing incoming entity ownership information on the left side of an entity box and the step of providing outgoing entity ownership information on the right side of a single entity box and of one or more related entity boxes provides methods for processing and displaying data using the computer-implemented methods in accordance with the present embodiment and ease of review for users to visualize complex entity relationships such as businesses with multiple layers of incoming and/or outgoing ownership interests with other entities. In accordance with this embodiment, the ability for a user to be able to easily see parent and child relationships between business entities may significantly enhance business transactions, objectives and review procedures.

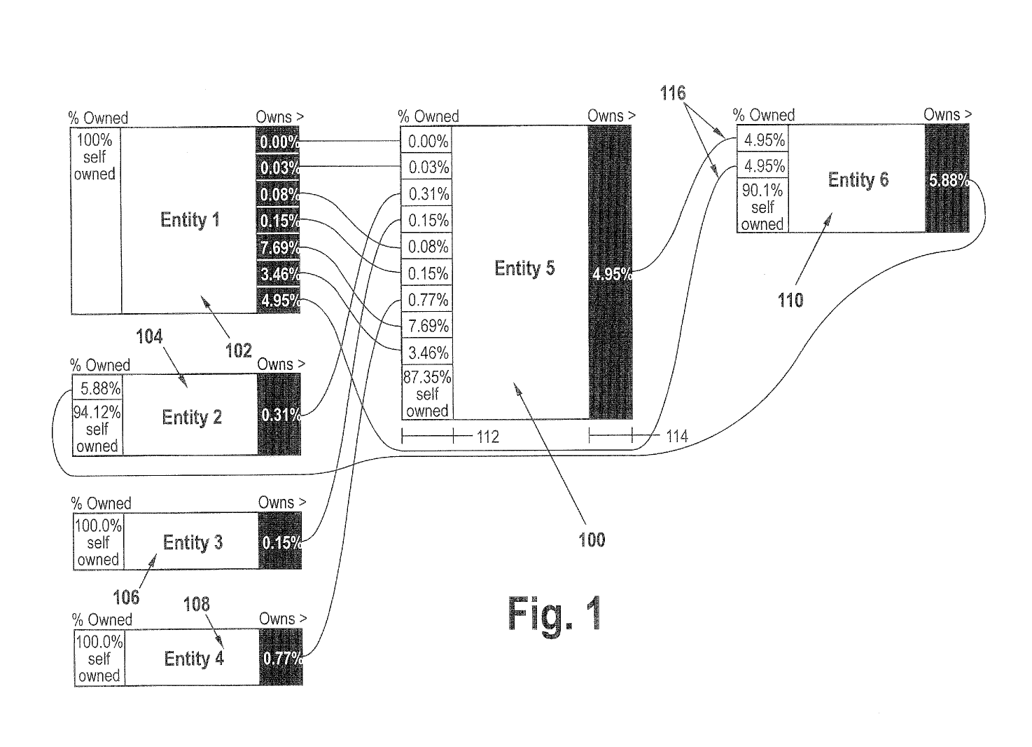

FIG. 1 provides a diagram showing a method of graph database processing and displaying complex relationships in accordance with one embodiment of the present invention. In accordance with this embodiment, entities with complex percentage ownership of other entities are being portrayed. In this figure, ownership interests of each entity is show in a left column 112, showing percentage of an entity owned by other entities, and in a right column, 114, showing percentage of other companies owned by an entity. Single edges 116 are shown connecting incoming and outgoing relationships of each entity, for ease of review of a user. In accordance with this embodiment, entity 5, 100 is shown with multiple other entities having ownership interests, specifically entity 1, 102, entity 2, 104, entity 3, 106 and entity 4, 108. Similarly in this embodiment, entity 5, 100 is further shown having ownership interest in entity 6, 110, while entity 1, 102 also has ownership interests in entity 6, 110. The figure further shows in this embodiment an ownership interest from entity 6, 110 to entity 2, 104. FIG. 1 further shows the interconnected relationships of entity 6, 110 highlighted, as the selected entity for a detailed review in the figure shown. As is apparent from the present figure, the entities shown have complex and interconnected relationships, which is simplified and easier to decipher using the computer-implemented methods, systems and features in accordance with the embodiments of the present invention.

In accordance with the present embodiment creating edges that are specific to the incoming and outgoing relationships is accomplished with unique methods of processing data in a computer-implemented program including but not limited to the steps of: 1) determining a start point (A) and ending point (B) of an entity relationship edge, 2) determining if a Bezier curve between each start (A) and ending point (B) will intersect any entity box, drawing a Bezier curve if the Bezier curve will not intersect any entity box, or alternatively moving the start point (A) to a different viable point on an X-plane. In accordance with a next set of steps, 3) if the start point (A) and end point (B) are on different planes or columns in the chart, proceeding to a next step of determining which direction to draw edges to go around the intersection box closest to start point (A), by comparing point A's Y-value with that of the intersecting box's midpoint. In a next set of steps, of 4) assigning a new start point (Aa) to be the X-value of the intersection box's left side, assigning the Y-value of the intersection box's top or bottom, plus half of the distance between the intersection box and the next box (offset for any other entity relationship lines that may already be there), drawing a Bezier curve from start point (A) to a new start point (Aa), determining a point (Ab) by adding the width of the intersecting box to point (Aa's) X-value, drawing a straight line from point Aa to Ab and repeating step 2. In another step in accordance with the present embodiment 5) if the start point (A) and end point (B) are on the same plane or columns in a chart, drawing an S-link and determining which direction to draw edges to go around the starting entity box by comparing starting point (A's) Y-value with that of the starting entity box's midpoint. In a next set of steps of 6) assigning a new start point (Aa) to be the X-value of the intersection box's left side, assigning the Y-value of the intersection box's top or bottom, plus half of the distance between the intersection box and the next box (offset for any other entity relationship lines that may already be there), drawing a Bezier curve from start point (A) to a new start point (Aa), determining a point (Ab) by adding the width of the intersecting box to point (Aa's) X-value, drawing a straight line from point Aa to Ab and repeating step 2.

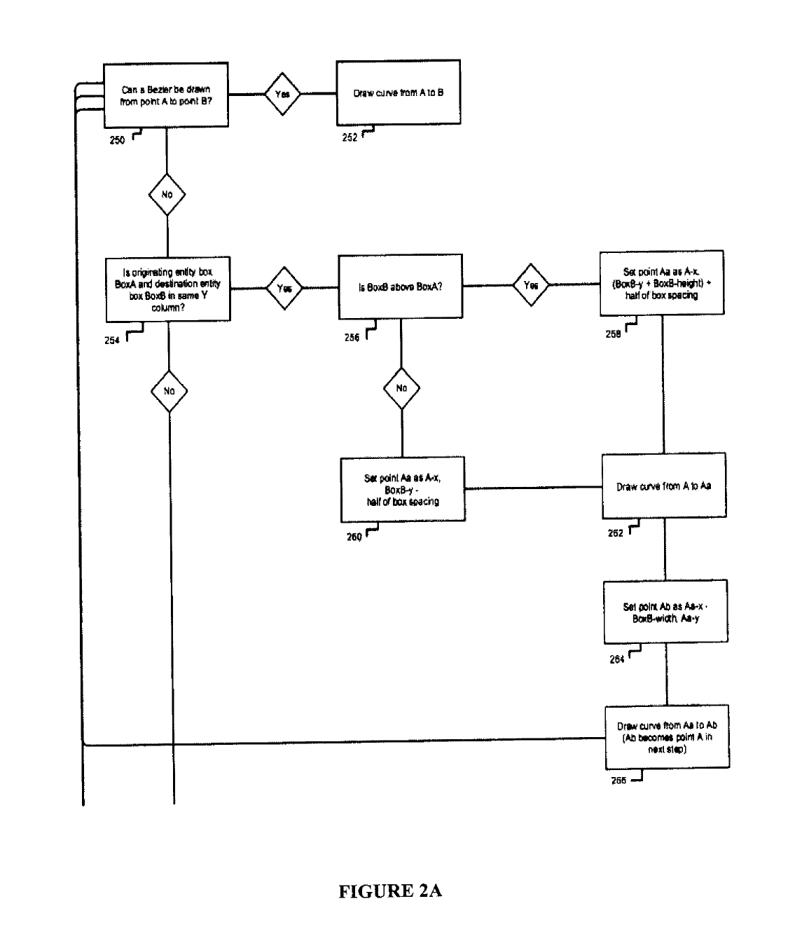

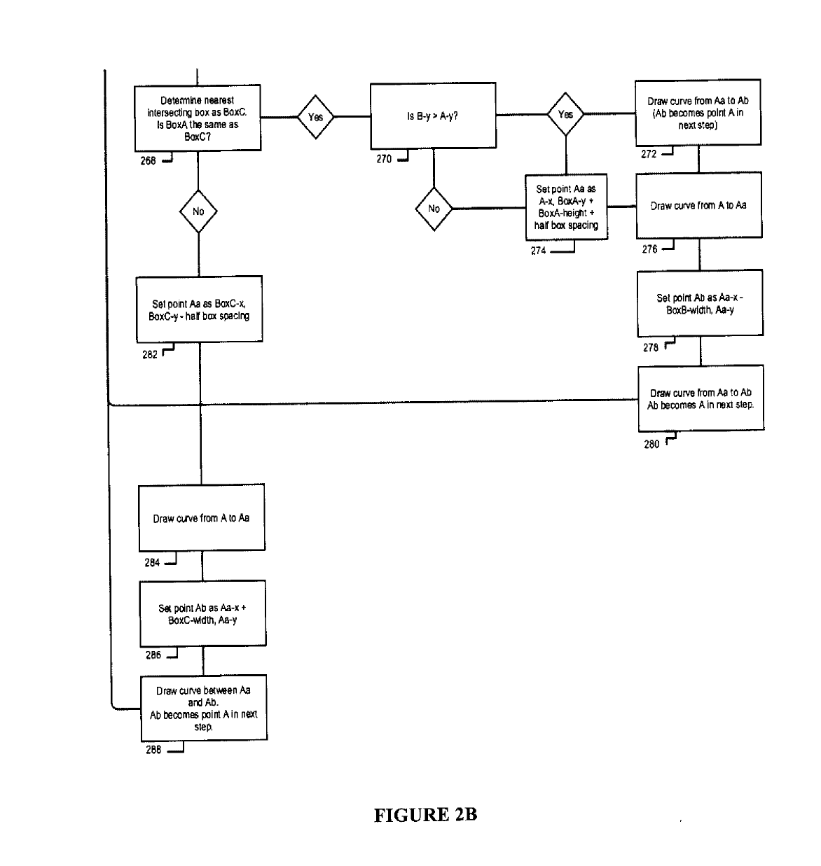

FIGS. 2A and 2B shows one such method of processing data in a computer-implemented program to display the unique and easy to review display of complex entity relationships in accordance with an embodiment of the present invention with the following process: determining if a Bezier curve can be drawn between a point A and a point B without intersecting any boxes, 250, if yes a curve is drawn between point A and point B, 252, if no, a next step of determining if Box A and Box B are in the same Y column, 254 is processed. If Box A and Box B are in the same column a next step of determining if Box B is above Box A, 256 is further processed, if yes, a start point of Aa is set as Aa-x (BoxB-y+BoxB-height) minus half of box spacing, 258; and a curve is drawn from A to Aa, 262, with a point Ab, set as Aa-x minus BoxB-width, Aa-y, and a curve may be drawn from Aa to Ab, 266, before returning to step 250. If BoxB is not above BoxA, a start point Aa is set as Aa-x (BoxB-y minus half of the box spacing), 260. In accordance with step 254 if the originating entity box BoxA and the destination entity box BoxB are not in the same Y column, a next step of determining if Box A is the nearest intersecting box to BoxC, 268, if yes then the methods of processing data for displaying complex entity relationships in accordance with the present invention determines if B-y is greater than A-y, if yes a start point Aa is set as A-x, BoxA-y minus half the box spacing, 272, and if no, the start point Aa is set as A-x, BoxA-y plus BoxA-height plus half the box spacing, 274, in order to draw a curve from A to Aa, 276, and a point Ab is set as Aa-x minus boxB-width, Aa-y, 278, in order to draw a curve from Aa to Ab, 280, before returning to step 250. In accordance with step 268 if the entity BoxA is not the nearest intersecting box to BoxC, a start point Aa is set as BoxC-x, BoxC-y minus half of the box spacing, 282. In accordance with this step a Bezier line may then be drawn between A and Aa, 284, and point Ab is set as Aa-z plus boxC-width, Aa-y, step 286, and a Bezier line is drawn between Aa and Ab before returning to step 250.

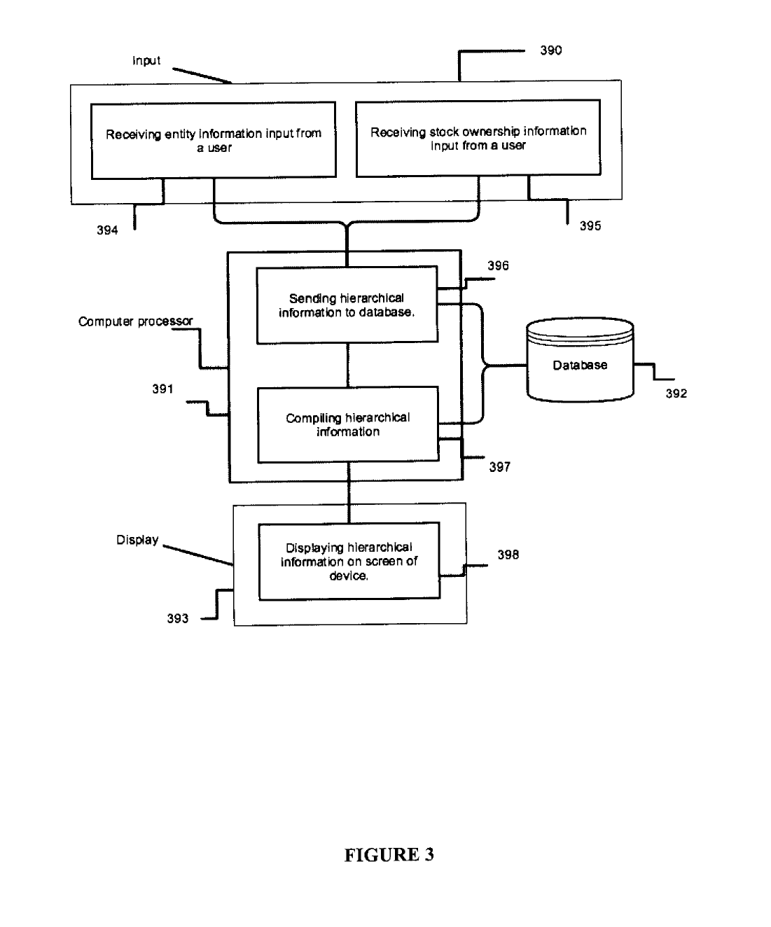

FIG. 3 shows methods and systems in accordance with the present invention of providing the computer-implemented processes for displaying complex entity relationships in accordance with the present invention. In accordance with this embodiment entity information data is input into a computer implemented program, step 390 by receiving entity information input from a user, step 394, and as an example in the form of receiving stock ownership information input from a user, step 395. A computer processor 391 will then compile hierarchical information, step 397 and send the hierarchical information to a database (shown as 392), step 396. In a final step, the computer processor 391 will create a display 393 in the form of hierarchical information on a screen of a device, 398, including a computer display, a mobile application, or like device.

Further embodiments of the present inventions provides for computer-implemented methods of graph data processing to visualize complex entity relationships, which requires a series of targeted computer-implemented developments to improve a user's ability to review complex entity relationships in accordance with the present invention. In this regard, the embodiments take into account a number of factors in graph data processing, including but not limited to: providing that an entity can only be shown once in a graph, identifying and representing all links between ownership nodes, and delivering data to a user in a JSON array, are beneficial for ease of data processing and ease of display in accordance with the present embodiments.

In addition in accordance with the present embodiment, further consideration is made to a number of factors in the computer-implemented graph data processing and display, as related to the entity boxes, including but not limited to: creation and sizing of the entity boxes, the sizing of the incoming and outgoing nodes and edges, the placement of text within the entity box and within the nodes, with extra consideration for multiple lines of text, and the placement of each entity box in the chart.

Yet further, in accordance with the present embodiment, important developments in the edges connecting the nodes or entities are further considered, including but not limited to: an edge may preferably start at its linking exit node on the right side of an entity box, an edge may preferably end at its linking entry node on the left side of an entity box, an edge may preferably be able to link to another box one level over (simple link), an edge may preferably be able to link to another box on the same level (s-linking), an edge may preferably be able to link to another box multiple levels deep (deep-linking), an edge may preferably be able to connect from a child's child, and go back to a parent to represent circular ownership (multi-level reverse s-linking), and an edge may preferably not intersect any entity box.

In addition, in accordance with the embodiments described herein, a graph data display may include a variety of tools and information for a user's convenience, including but not limited to email notifications, pop-up notifications, highlights, images, pictures or the like, for ease of review by a user.

### Industry Implications

The present invention may be used in almost any industry to improve visualization of complex entity relationships. As a few mere examples, which is not meant to be limiting in scope as many other unrelated examples and fields of use exist, the present invention may be useful in the following industries: financial, logistics, marketing, medical, legal and educational.

### Financial

In the financial industry, the present invention may be useful, amongst other ways undisclosed herein, in a data-mining application to scour social media pipelines for brand-related news, comments, and tweets. A financial institution may offer the present invention to clients as a way to quickly see which of their investments (and related entities of these investments) may be on the cusp of an opportunity, which may affect investment decisions. In addition real-time financial updates using the present invention to visualize complex investment relationships may be helpful to an investment banker to keep up to date on portfolio needs. The present invention may further be useful to show ownership relationships in complex structures such as REIT's, hedge funds, private equity firms and other complex investment vehicles.

### Logistics

A shipping company may also utilize the present invention to manage and optimize incoming and outgoing delivery pipelines to identify bottlenecks, manage relationships with trucking companies and their throughput, and predict spikes in demand based on warehouse activity.

A manufacturing company may also utilize the present invention by building a complex product (automotive, aerospace, medical equipment) to keep track of and easily view all of the relationships between the parts and the end products, the companies involved with their manufacturing, and overlaps in production, in order to optimize productivity.

### Marketing

Tracking customer behavior and utilizing the present invention to visualize customer behavior may provide retailers with insight into timely marketing opportunities.

### Medical

The present invention may also be helpful in the medical industry, including but not limited to the following benefits: for mapping treatment vectors for a condition or injury, with percentages of success based on data points about a patient, for displaying the relationships between research and clinical studies, with patients' genetic markers and responses to treatment to develop better medicine and procedures, for visualizing a treatment's success rates on different types of patients, showing the relationships between different patient responses based on human metrics, such as age, weight, and genealogical patterns.

### Legal

The present invention may further be useful in the legal industry to chart the relationships of various cases, judicial decisions, along with related laws and precedents. In this instance nodes may contain a positive or negative heat map of positive relationships to a particular legal concept, or a relevancy percentage of decisions that would influence the use of a legal precedent. The present invention may also be useful to show legal ownership relationships for commercial real estate and graphic representations of capitalization tables for all types of legal entities.

### Education

In addition, in the education field, the present invention may be utilized and combined with student metrics, to easily review success rates for a particular lesson plan, to review success rates of an entire curriculum, or to review teacher performance.

It should be emphasized that the above-described embodiments of the present invention are merely possible examples of implementations and are merely set forth for a clear understanding of the principles of the invention. Many variations and modifications may be made to the above-described embodiments of the invention without departing substantially from the spirit and principles of the invention. All such modifications and variations are intended to be included herein, within the scope of this disclosure and the present invention, and protected by the following claims.

1. A computer-implemented method of graph data processing of complex entity relationships, the method comprising the steps of:
storing graph data on a processor representing complex entity relationships;
generating, with said processor, a listing of incoming relationship information of a first entity by one or more entities;
generating, with said processor, a listing of outgoing relationship information by said first entity of said one or more entities;
converting said incoming relationship information and said outgoing relationship information, using a processor, into a single entity box display; and,
connecting said incoming relationship information and said outgoing relationship information from said single entity box display with single edges directed to incoming relationship information and single edges directed to outgoing relationship information in one or more related entity boxes, wherein said single edges each connect to one incoming relationship and one outgoing relationship in said one or more related entity box.

2. The method in accordance with claim 1 further including the step of displaying said single edges on the outside of said single entity box with said one or more related entity box.

3. The method in accordance with claim 2 further including the step of preventing said single edges from intersecting said single entity box and said one or more related entity box in a computer-implemented display.

4. The method in accordance with claim 1 further including the step of providing a computer-implemented display of incoming relationships in nodes on the left side of said single entity box and said one or more related entity box.

5. The method in accordance with claim 4 further including the step of providing a computer-implemented display of outgoing relationships in nodes on the right side of said single entity box and said one or more related entity box.

6. The method in accordance with claim 1 further including the step of providing a computer-implemented display of incoming percentage ownership information on the left side of said single entity box and said one or more related entity box.

7. The method in accordance with claim 6 further including the step of providing a computer-implemented display of outgoing percentage ownership information on the right side of said entity box.

8. The method in accordance with claim 1 further including the step of providing a computer-implemented display of detailed entity relationship information when said single entity box is selected by a user.

9. The method in accordance with claim 8 further including the step of providing a computer-implemented highlighted display of said detailed entity relationship information when said single entity box is selected by a user.

10. The method in accordance with claim 9 further including the step of providing a computer-implemented highlighted display of said edges and said nodes connected to a single entity box when said single entity box is selected by a user.

11. The method in accordance with claim 8 further including the step of providing a computer-implemented 3D image of said detailed entity relationship information when said single entity box is selected by a user.
